(19) United States
(12) Patent Application Publication
(10) Pub. No.: US 2003/0090104 A1
(43) Pub. Date: May 15, 2003

(54) Device for securing a hose clamp to a hose

(76) Inventor: Frederick W. Woodward, Dexter, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/003,141

(22) Filed: Nov. 15, 2001

(51) Int. Cl. F16L 55/00

(52) U.S. Cl. 285/23; 285/915

(57) ABSTRACT

A device for securing a hose clamp having an adjustment mechanism to a section of a flexible hose adjacent one end of the hose is disclosed. The device comprises an elongated web constructed of a flexible material. An adhesive material is disposed along at least a portion of one side of the web while the web is divided into a plurality of longitudinally adjacent tape segments. Each tape segment is substantially U-shaped having spaced sides, a base and thus forming a rectangular opening between the sides and the base. This rectangular opening, furthermore, is dimensioned to receive at least a portion of the clamp adjustment mechanism such that, in doing so, a portion of the tape segment overlies both a portion of the hose clamp as well as the hose.

### BACKGROUND OF THE INVENTION

I. Field of the Invention

The present invention relates generally to a device for securing a hose clamp to a flexible hose.

II. Description of Related Art

In the manufacture of many articles, such as automotive vehicles, it is oftentimes necessary to secure flexible or resilient hoses to fluid connectors within the vehicle. Conventionally, with the end of the hose positioned over the hose connector, a hose clamp having an adjustment mechanism along a portion of its length is positioned around the hose adjacent the end of the hose. Upon tightening of the hose clamp using the adjustment mechanism, the hose clamp tightens the resilient hose against the fluid connector thus completing the fluid seal between the hose and the connector.

In view of increasingly stringent government regulations in the automotive and other industries, it is necessary that the hose clamp be accurately positioned relative to the end of the hose prior to tightening of the hose clamp in order to achieve an essentially zero leak fluid connection between the hose and its connector. Unless the hose clamp is precisely positioned relative to the hose, tightening of the hose clamp may result in a less than ideal seal between the hose and its connector thus allowing leakage between the hose and the connector.

Inclusion of the clamp as part of the hose assembly reduces the number of separate components of the facility making the final connection to the hose. Holding the clamp in position enables one-handed tightening of the clamp.

There have, however, been several previously known attempts to accurately position the hose clamp relative to the end of the hose prior to assembly of the hose to its connector. In at least one prior art device, a piece of rubber was vulcanized to the outer surface of the hose thus attaching the hose clamp to the hose at the desired position. While this previously known method accurately positioned the hose clamp on the hose, the manufacturing process of attaching the hose clamp to the hose was unduly expensive. Furthermore, such vulcanization of the piece of rubber onto the hose can result in unacceptable damage to the hose itself.

In still a further attempt to properly locate the hose clamp relative to the end of the hose, an elongated wire had one end disposed over the open end of the hose and its other end attached to the hose clamp. Thus, with the wire disposed over the open end of the hose, the hose clamp was precisely positioned relative to the end of the hose. While this previously known device accurately positioned the hose clamp relative to the end of the hose, in some cases the wire would damage the fluid connector by scratching the fluid connector during the insertion of the hose over the fluid connector. Such scratching, in turn, can adversely affect the fluid seal between the hose and the fluid connector.

A further prior art device from Goodyear has supplied prototypes with a plastic cloth (square shape) bonded to the hose/clamp with an adhesive applied separately.

### SUMMARY OF THE PRESENT INVENTION

The present invention provides a device which overcomes all of the above-mentioned disadvantages of the previously known devices.

In brief, the device of the present invention comprises an elongated web which is constructed of a flexible material, such as cloth or paper. Preferably, the web is fiber reinforced for added strength.

An adhesive material is disposed along at least a portion of one side of the web. Preferably, a backing strip is removably disposed along one side of the web thus covering the adhesive until use of the web is required.

The web is divided into a plurality of longitudinally adjacent tape sections, each of which is preferably separated from each other by a series of laterally extending perforations. Each tape segment, furthermore, is substantially U-shaped thus having spaced sides, a base and forming a rectangular opening between the sides and the base. This rectangular opening is dimensioned to receive at least a portion of the clamp adjustment mechanism of the hose clamp.

In operation, a tape segment is removed from the web and positioned over the hose clamp so that the adjustment mechanism is positioned within the rectangular space while the tape segment overlies both a portion of the hose clamp as well as a portion of the hose. The adhesive, furthermore, is selected so that it adheres both to the material of the hose clamp as well as the material of the hose such that the tape segment secures the hose clamp against both axial as well as rotational movement relative to the hose.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a fragmentary view illustrating a preferred embodiment of the present invention;

FIG. 2 is an elevational view of the preferred embodiment of the invention;

FIG. 3 is a planar view illustrating the use of the preferred embodiment of the present invention; and

FIG. 4 is a fragmentary sectional view taken substantially along line 4-4 in FIG. 1 and enlarged for clarity.

### DETAILED DESCRIPTION OF A PREFERRED EMBODIMENT OF THE PRESENT INVENTION

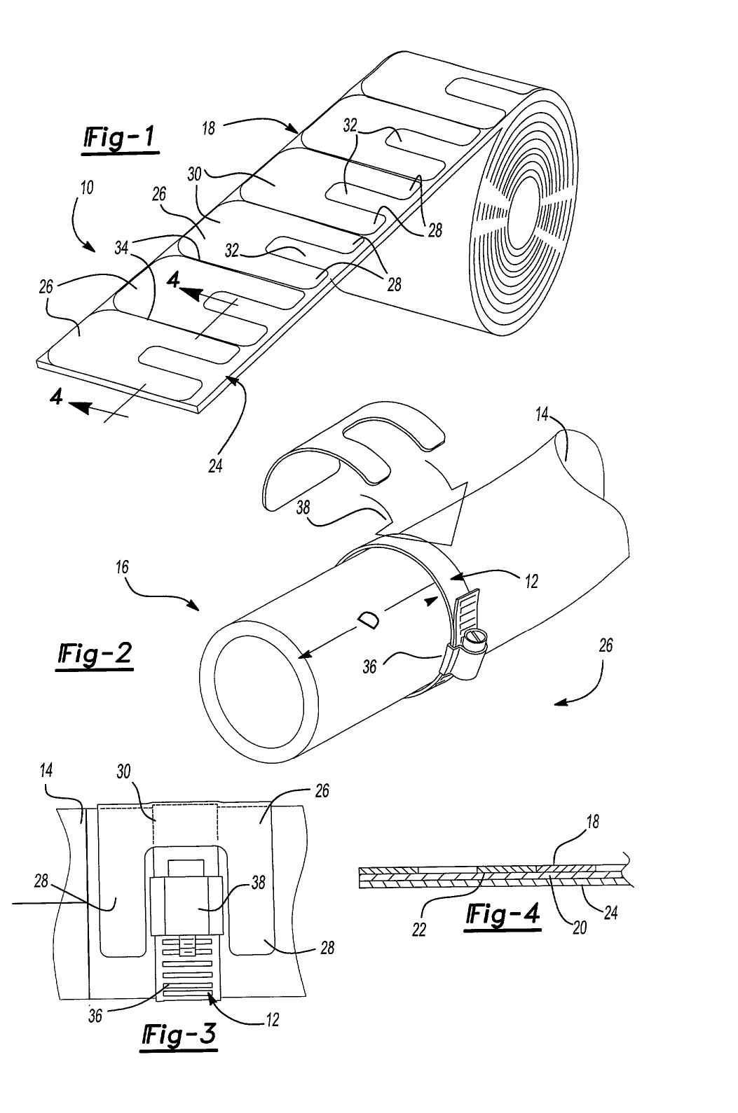

With reference first to FIGS. 1, 2 and 3, a preferred embodiment 10 of the present invention is there shown for securing a hose clamp 12 to a flexible or resilient hose 14 so that the clamp 12 is positioned a preset distance from one end 16 of the hose 14. The actual attachment of the hose clamp 12 to the hose 14, however, will be subsequently described in greater detail.

With reference then to FIGS. 1 and 4, the device 10 comprises an elongated web 18 constructed of a flexible material, such as paper or cloth. Preferably, the web 18 is fiber reinforced for added strength.

As best shown in FIG. 4, an adhesive layer 20 is disposed along at least a portion of one side 22 of the web 18. Furthermore, a removable backing strip 24 is preferably disposed along the side 22 of the web 18 such that the backing strip 24 overlies the adhesive layer 20.

As best shown in FIG. 1, the web 18 comprises a plurality of longitudinally adjacent tape segments 26, each of which are substantially identical to each other. Each tape segment 26 is substantially U-shaped thus having two spaced sides 28 and a base 30 which, together, form a U-shape around space 32.

In order to enable the tape segments 26 to be easily separated from each other, preferably at least one laterally extending perforation 34 is formed between adjacent tape segments 26. This elongated perforation 34 may comprise a single slit or a series of perforations formed through the web 18.

With reference now to FIGS. 2 and 3, the hose clamp 12 includes both a band 36 which circumscribes the hose 14 adjacent but spaced from its open end 16. Furthermore, an adjustment mechanism 38 extends circumferentially along a portion of the band 36. This adjustment mechanism 38, such as a screw which engages the band 36 through a worm gear, protrudes radially outwardly from the band 36.

The base 30 and sides 28 of each tape segment 26 are dimensioned so that at least a portion of the clamp adjustment mechanism 38 is positioned within the opening 32 of the U-shaped tape segment 26 as shown in FIG. 3. In doing so and with the backing strip 24 removed, the sides 28 of each tape segment 26 are flatly positioned along the outer surface of the hose 14 on opposite longitudinal ends of the clamp adjustment mechanism 38. Simultaneously, a portion of the base 30 of the tape segment 26 overlies a portion of the hose clamp band 36. Furthermore, the adhesive 20 is selected so that it adheres to both the hose 14 as well as the clamp band 36 so that, with the tape segment 26 positioned as shown in FIG. 3, the tape segment 26 accurately positions and secures the clamp 12 to the hose 14 at the desired distance from the end 16 of the hose.

Since the clamp adjustment mechanism 38 forms a major portion of the total weight of the clamp 12, securing the tape segment 26 to the hose 14 and clamp 12 around the adjustment mechanism 38 minimizes movement of the clamp 12 relative to the hose 14 prior to final assembly of the hose 14 onto its connector, such as a barbed stub. Such movement would otherwise occur from torque loads imposed on the clamp 12 by the relatively heavy adjustment mechanism 38 during movement of the hose 14 prior to final assembly of the hose 14 onto its connector. This, in turn, minimizes the possibility of the tape segment 24 ripping prior to final assembly of the hose 14 onto its connector.

While in the preferred embodiment of the invention the tape segments 26 are preferably individually removed from the web 18 which itself is preferably in the form of a spool, the tape segments 26 may alternatively be individually and separately packaged.

From the foregoing, it can be seen that the present invention provides a simple and yet inexpensive means for securing a hose clamp to a hose. Since the tape segment 26 merely secures the hose clamp to the hose to facilitate the tightening of the hose clamp 12 around the hose 14, after the hose is secured to its connector by the hose clamp, the tape segment performs no further function. Consequently, the tape segment 26 may be constructed of a relatively inexpensive material without sacrifice of its effectiveness.

Having described my invention, however, many modifications thereto will become apparent to those skilled in the art to which it pertains without deviation from the spirit of the invention as defined by the scope of the appended claims.

I claim:

1. A hose assembly comprising:
a length of flexible hose having first and second spaced ends,
a clamp assembly, said clamp assembly having a band circumscribing said hose adjacent said first end of said hose,
a tape segment having a layer of adhesive disposed on one side of said tape segment, said one side of said tape segment being disposed across a portion of said clamp assembly band and a portion of said hose to thereby secure said clamp assembly to said hose.

2. The invention as defined in claim 1 wherein said tape segment comprises a fiber reinforced web.

3. The invention as defined in claim 2 wherein said web is constructed of cloth.

4. The invention as defined in claim 1 wherein said adhesive is selected such that said adhesive adheres to both said hose and said clamp.

5. The invention as defined in claim 1 wherein said tape segment is substantially U-shaped.

6. The invention as defined in claim 1 wherein said tape segment is substantially H-shaped.

7. The invention as defined in claim 1 wherein said clamp assembly comprises an adjustment mechanism along a portion of said band, said adjustment mechanism extending for only a portion of the circumferential length of said band, and wherein said tape segment is U-shaped having two sides, a base and forming a rectangular space between said sides and said base, said adjustment mechanism being positioned within said rectangular space.

8. A device for securing a hose clamp having an adjustment mechanism along a portion of its length to a section of hose adjacent one end of the hose section comprising:
an elongated web constructed of a flexible material,
an adhesive material being disposed along at least a portion of one side of said web,
said web having a plurality of longitudinally adjacent tape segments,
wherein each of said web segments is substantially U-shaped having spaced sides, a base and forming a rectangular opening between said sides and said base, said rectangular opening dimensioned to receive at least a portion of the clamp adjustment mechanism therein.

9. The invention as defined in claim 8 and comprising a backing strip removably disposed on said one side of said web over said adhesive material.

10. The invention as defined in claim 8 wherein said flexible material comprises a fiber reinforced flexible material.

11. The invention as defined in claim 8 and comprising at least one opening formed through said web between each tape segment.

12. The invention as defined in claim 11 wherein said at least one opening comprises a plurality of laterally extending perforations.

13. The invention as defined in claim 11 wherein said at least one opening comprises a transversely extending slit extending through said web.

14. A device for securing a hose clamp having an adjustment mechanism along a portion of its length to a section of hose adjacent one end of the hose section comprising:
a tape segment constructed of a flexible material,
an adhesive material being disposed along at least a portion of one side of said tape segment,
wherein said tape segment is substantially U-shaped having spaced sides, a base and forming a rectangular opening between said sides and said base, said rectangular opening dimensioned to receive at least a portion of the clamp adjustment mechanism therein.

15. The invention as defined in claim 14 and comprising a backing strip removably disposed on said one side of said web over said adhesive material.

16. The invention as defined in claim 14 wherein said flexible material comprises a fiber reinforced flexible material.

17. The invention as defined in claim 13 wherein said tape segment is substantially H-shaped.
